(19) United States
(12) Patent Application Publication
(10) Pub. No.: US 2021/0342737 A1
(43) Pub. Date: Nov. 4, 2021

(54) AI/ML BASED PROACTIVE SYSTEM TO IMPROVE SALES PRODUCTIVITY BY CATEGORIZING AND DETERMINING RELEVANT NEWS

(71) Applicant: EMC IP Holding Company LLC, Hopkinton, MA (US)

(72) Inventors: Shubham Gupta, Jaipur (IN); Rohan Sharma, Delhi (IN); Rangan Basu, Gurgaon (IN)

(21) Appl. No.: 16/864,190

(22) Filed: May 1, 2020

(51) Int. Cl. G06N 20/00; G06Q 10/06; G06Q 30/02; G06F 40/30; G06F 40/295

(52) U.S. Cl. CPC G06N 20/00; G06Q 10/067; G06F 40/295; G06F 40/30; G06Q 30/0201

(57) ABSTRACT

A machine learning (ML) module that automates the screening of the news articles in the search results received from an online news aggregator and intelligently selects only those articles for presentation to a user that are really important in creating potentially new business transactions with the user's clients. Other non-relevant or marginally-relevant news are removed to avoid distractions. The ML module analyzes commercial information—such as, for example, the product/service offerings (current and in the near future) of the corporate entity employing the user, historical sales and marketing information related to the user's client, current account status of the client, and past business transactions with the client—to intelligently select the most relevant news articles for the user. The ML module goes beyond the existing news aggregator platforms by curating the aggregator-provided results and selecting only those news articles that hold promise in exploring new business opportunities with a client.

### TECHNICAL FIELD

This disclosure relates generally to screening of online news articles and, more particularly, to an Artificial Intelligence (AI) based selection of news articles that are highly relevant to a corporate client/account in terms of potential business opportunity.

### BACKGROUND

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Modern information handling systems include many different types of consumer and commercial electronic devices such as, for example, personal computers (e.g., desktops or laptops), tablet computers, mobile devices (e.g., personal digital assistants (PDAs) or smart phones), corporate (or small business) server and data processing systems, and the like. These devices may vary in size, shape, performance, functionality, and price. In any event, almost all of these modern devices are equipped with relevant hardware and software to allow their users to access a number of different websites over the Internet and perform online transactions.

In a corporate environment, the sales and marketing team members increasingly rely on information handling systems to access the Internet to mine information and online news articles related to their clients to check if new business opportunities can be created with the clients. Currently, there are a lot of news sources out there in the market. Also, there are many online news aggregators such as, for example, Google® News, Yahoo® News, and so on, that have the capability to collect and filter news from a number of online news sources (such as, for example, The New York Times, CNN, Reuters, Wall Street Journal, Forbes, Financial Times, and the like) based on a particular area of interest or particular filter criterion (for example, the name of a corporate client) provided by a user (such as a salesperson or an Account Executive (AE) of a corporate entity). These news aggregators allow the user to view the news headlines (or news summaries) from different news sources on the display screen of the user's information handling system. The user can then click on the link of the desired news article to read the entire article from the website of the news source.

### SUMMARY

This Summary provides a simplified form of concepts that are further described below in the Detailed Description. This Summary is not intended to identify key or essential features and should therefore not be used for determining or limiting the scope of the claimed subject matter.

In the context of screening of online news articles, the present disclosure relates to using an AI-based machine learning (ML) module to further curate the news articles filtered by an online news aggregator. The ML module automates the process of selecting news articles that are most relevant to the corporate entity in creating new business opportunities with its customers/clients. With the boom of information in the modern world, it may be difficult for a corporate salesperson or AE to manage and keep up with all the online news and market trends related to the clients in the AE's portfolio. For a set of news articles provided by a news aggregator service (like Google® News or Yahoo® News), the ML module automates and streamlines the process of sifting through these news articles to intelligently select and present only those news articles to the corporate user (for example, the salesperson or AE) that are really important to the user in creating potential, new business transactions with the user's clients. Other non-relevant or marginally-relevant news may be removed from the search results received from the news aggregator to avoid distractions. In doing so, the ML module may rely on many different types of commercial information—such as, for example, the corporate entity's product/service offerings (current and in the near future), historical sales and marketing information related to a client, current account status of the client, and past business transactions with the client—to intelligently select the most relevant news articles for the user.

In one embodiment, the present disclosure is directed to a method, which comprises: (i) receiving, by a computing system, a list of online news articles related to a client of a corporate entity, wherein the list contains news articles generated within a pre-determined time period and pre-sorted by an online news aggregator; (ii) identifying, by the computing system using a machine learning (ML) module, a first subset of online news articles from the list that are relevant to a commercial area of interest specific to the corporate entity; and (iii) selecting, by the computing system using the ML module, a second subset of online news articles from within the first subset based on an analysis of corporate entity-specific business data and commercial capabilities of the corporate entity, wherein the second subset contains news articles that are specifically relevant for a potential business transaction with the client. The ML module may be AI-based. In particular embodiments, the method further comprises presenting the online news articles in the second subset in an ordered manner—starting with the most-relevant news article at the top and ending with the least-relevant news article.

In another embodiment, the present disclosure is directed to a computing system, which comprises: a memory storing program instructions; and a processing unit coupled to the memory and operable to execute the program instructions. In the computing system, the program instructions, when executed by the processing unit, cause the computing system to: (i) receive a list of online news articles related to a client of a corporate entity, wherein the list contains news articles generated within a pre-determined time period and pre-sorted by an online news aggregator; (ii) identify, using an ML module, a first subset of online news articles from the list that are relevant to a commercial area of interest specific to the corporate entity; and (iii) select, using the ML module, a second subset of online news articles from within the first subset based on an analysis of corporate entity-specific business data and commercial capabilities of the corporate entity, wherein the second subset contains news articles that are specifically relevant for a potential business transaction with the client.

In a further embodiment, the present disclosure is directed to a computer program product comprising a non-transitory computer-usable medium having computer-readable program code embodied therein, wherein the computer-readable program code is adapted to be executed by a computing system to implement a method. The method comprises: (i) receiving a list of online news articles related to a client of a corporate entity, wherein the list contains news articles generated within a pre-determined time period and pre-sorted by an online news aggregator; (ii) identifying, using a machine learning (ML) module, a first subset of online news articles from the list that are relevant to a commercial area of interest specific to the corporate entity; and (iii) selecting, using the ML module, a second subset of online news articles from within the first subset based on an analysis of corporate entity-specific business data and commercial capabilities of the corporate entity, wherein the second subset contains news articles that are specifically relevant for a potential business transaction with the client.

The ML module as per teachings of the present disclosure is an AI-based analytical tool that goes beyond the existing news aggregator platforms to intelligently provide highly-relevant, customer/account specific news to respective account executives (AEs) based on a number of different types of company-specific commercial information mentioned earlier. This saves a significant amount of time of an AE when searching online for commercially-significant client-specific news that can create potentially new business opportunity with the client. The AE may not need to manually sift through a large amount of online content presented by the news aggregator in order to extract what is most relevant for the AE's future business with the client. This pro-active approach enables the AE to focus more on client development and gain customer's confidence in the company's product/service portfolio through client-specific, targeted marketing that takes into account the latest news and market trends affecting the client. In turn, the corporate entity gets financially rewarded through new business opportunities.

### BRIEF DESCRIPTION OF THE DRAWINGS

A more complete understanding of the present disclosure may be obtained by reference to the following Detailed Description when taken in conjunction with the accompanying Drawings. For ease of discussion, the same reference numbers in different figures indicate similar or identical items.

FIG. 1 shows an exemplary block diagram showing how a relevant news selection module as per particular embodiments of the present disclosure may be implemented.

FIG. 2 is an exemplary flowchart depicting various steps that may be performed by a computing system as per particular embodiments of the present disclosure to carry out news selection using the RNS module of FIG. 1.

FIG. 3 is an exemplary illustration of how search results from an online news aggregator may be screened for the most relevant news using the RNS module of FIG. 1.

FIG. 4 is an exemplary flowchart providing an overview of various operational phases of the RNS module of FIG. 1 as per certain embodiments of the present disclosure.

FIG. 5 shows an exemplary flowchart of how an ML classifier may be selected as part of generating a trained version of the RNS module of FIG. 1 as per particular embodiments of the present disclosure.

FIG. 6 is an exemplary block diagram illustrating the determination of relevance percentile by the RNS module of FIG. 1 as per some embodiments of the present disclosure.

FIG. 7 illustrates an example configuration of a computer system that can be used to implement the news selection methodology described herein.

### DETAILED DESCRIPTION

For purpose of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, a network controller, or any other suitable device, and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, touch-screen and/or video display. The information handling system may also include one or more buses operable to transmit communications between the various hardware components.

It is noted here that, for ease of discussion, a computer software, program code or module may be referred to as “performing,” “accomplishing,” or “carrying out” a function or process. However, it is evident to one skilled in the art that such performance may be technically accomplished by a processor when the software or program code is executed by the processor. The program execution would cause the processor to perform the tasks or steps instructed by the software to accomplish the desired functionality or result. However, for the sake of convenience, in the discussion below, a processor or software component may be referred to interchangeably as an “actor” performing the task or action described, without technically dissecting the underlying software execution mechanism. Furthermore, a hyphenated term (e.g., “pre-determined”, “computer-readable”, “AI-based”, etc.) may be occasionally interchangeably used with its non-hyphenated version (e.g., “predetermined,” “computer readable”, “AI based”, etc.), and a capitalized entry (e.g., “News Aggregator”, “News Article,” “Relevant News Selection Module”, etc.) may be interchangeably used with its non-capitalized version (e.g., “news aggregator,” “news article,” “relevant news selection module”, etc.). Such occasional interchangeable uses shall not be considered inconsistent with each other.

As mentioned before, with the boom of information in the modern world, it may be difficult for a corporate salesperson or AE to manage and keep up with all the online news and market trends related to the clients in the AE's portfolio. Although the AE may be able to use the search facility provided by an online news aggregator (such as, for example, Google® News, Yahoo® News, and the like) to filter news from multiple sources based on selection of a desired category of news or a specific search term, there is still a lot of news that gets generated on a daily basis and the news aggregator may not determine what is specifically relevant to the AE. As a result, even though the AE can subscribe to certain news topics through the news aggregator's website (or search engine) or get news based on desired categories or keywords, the AE still can't really know which news article(s) in the list of search results received from the aggregator are really important for the AE in terms of creating a new business opportunity with the clients in AE's portfolio.

For example, if an AE is working for a corporate entity or company that provides technological products and/or services and if the AE manages the account of a national burger chain, the AE may sign-up with an online news aggregator and subscribe to news (or news feeds) mentioning the name of AE's client (here, the burger chain) so that the AE can stay up-to-date with the latest happenings with the client in the marketplace to look for any possible business opportunity for future sales or other commercial transaction. The news aggregator may suggest multiple stories generated within the time period specified by the AE (for example, last one week, or last 10 days) and mentioning the AE's client by name. However, the AE may not have enough time to go through every story in detail—starting from top of the list to the bottom of the list—to figure out if the news article is indeed relevant to the AE's company's line of business. There is simply no way for the AE to know from looking at the aggregator's search results which articles are relevant for the AE and which are not. For example, if a news article discusses introduction of a new burger or a new burger sauce by the AE's client, then that article is simply irrelevant to the AE's line of work. If many such articles appear on the top of the list presented by the news aggregator, then the AE may expend and waste a large amount of time sifting through them while the most relevant news article—from AE's perspective—may be somewhere at the bottom of the list. That most-relevant news article may contain news about AE's client acquiring a new technology start-up and may choose to invest heavily in Information Technology (IT) infrastructure/hardware as a result of the acquisition. In many cases, the AE may even miss this important article because of the plethora of irrelevant or marginally-relevant articles the AE may need to go through. This results in a loss of potential business opportunity and, hence, loss of revenue for AE's employer. When this situation is multiplied by the total number of accounts managed by an AE (for example, 50 clients/accounts, or 100 clients/accounts) and the total number of AEs in a company (which may run into thousands or even tens of thousands for a large multi-national corporation), the potential for lost business opportunities may grow exponentially. The overwhelming amount of news presented to the AE for review may be quite time-consuming, especially in view of the need for the AE to also perform his/her job-related sales and marketing tasks including client calls, visits to client sites, sales presentations, and so on. Therefore, the demands of job duties and the limited amount of time available for news reviews may result in a realistic possibility of an AE missing the highly-relevant client-specific news and losing a possible business opportunity.

It is therefore desirable to devise a methodology that can alleviate the news-screening burden on an AE by providing an automated tool that can remove the uncertainties, delays, and risks inherent in a manual screening of online news. It is further desirable that the tool can curate the news received from an online news aggregator based on a number of criteria specific to the corporate entity employing the AE and to the client portfolio of the AE, and select only those news articles for review by the AE that are most relevant in creating new business opportunities with AE's customers/clients.

The present disclosure relates to automated selection of client-specific relevant news based on machine learning (ML) techniques. In one embodiment, an AI-based relevant news selection module (an ML module) automates and streamlines the process of screening the news articles appearing in the search results received from an online news aggregator and intelligently selects only those articles for presentation to a user (for example, a corporate salesperson or AE) that are really important to the user in creating potentially new business transactions with the user's clients in the near future. Other non-relevant or marginally-relevant news may be removed to avoid distractions. The ML module may rely on many different types of commercial information—such as, for example, the product/service offerings (current and in the near future) of the corporate entity employing the user, historical sales and marketing information related to a user's client, current account status of the client, and past business transactions with the client—to intelligently select the most relevant news articles for the user. Thus, the ML module goes beyond the existing news aggregator platforms by further curating the aggregator-provided results and selecting only those news articles that hold promise for an AE in exploring new business opportunities with a client.

It is noted here that the terms “corporate entity,” “company,” or other terms of similar import may be used interchangeably herein to refer to a business entity or commercial enterprise that employs at least one salesperson or AE who manages at least one client account as part of his/her account portfolio. Similarly, the terms “user,” “salesperson,” “account executive” (or “AE”), or other terms of similar import may be used interchangeably herein to refer to a marketing team member or a sales staff member of a company who may benefit from the selection of relevant news as per teachings of the present disclosure. Additionally, the terms “client” or “account” may be used interchangeably as well to refer to a customer of the corporate entity managed by an AE as part of the AE's job portfolio. It is understood that the client itself may be a business entity as well.

It is further noted here that, merely for ease of discussion, the term “online” may not always appear along with the terms “news,” “news article,” “news source,” “news aggregator,” and the like. However, it is understood that, despite such absence of mention, the discussion herein applies to selection of news articles appearing online (for example, over the Internet). It is also understood that, for ease of discussion, the terms “news” or “news articles” are used as a short-hand to refer to the summaries or web links appearing in the search results received from a news aggregator. As discussed before, a user may click on the desired link to read the entire news article from the respective news source.

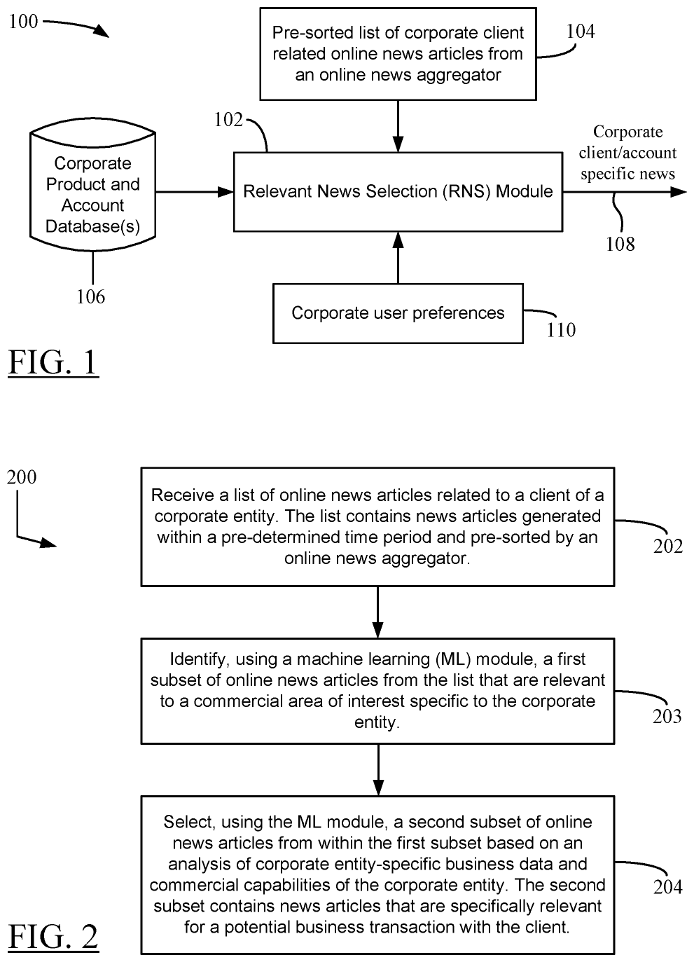

FIG. 1 shows an exemplary block diagram 100 showing how a relevant news selection (RNS) module 102 as per particular embodiments of the present disclosure may be implemented. The RNS module 102 also may be referred to herein as the “ML module.” In particular embodiments, the RNS module 102 may be an AI-based software application comprising program code, which, upon execution by a processor in an information handling system (such as the processor 702 in the computer system 700 in FIG. 7), may cause the information handling system to perform various operational tasks discussed below with reference to FIGS. 2-6. The information handling system may be owned or operated by a user (such as a salesperson or an AE) who is desirous of utilizing the RNS module 102 for automated selection of news articles highly relevant to the user's client portfolio. In some embodiments, the RNS module 102 may function as a stand-alone software application or part of another software application (such as, for example, a data mining software) that is configured to interact with the user's web browser or other similar software. In this configuration, the RNS module 102 may be running on an information handling system that is different from the system through which the user's web browser is connected to the Internet and receiving the list of news articles from a news aggregator. In other embodiments, the RNS module 102 may be integrated with the user's web browser as an add-on component that automatically screens the list of news articles received by the browser from an online news aggregator. The operational details of the RNS module 102 are given below with reference to FIGS. 2-6.

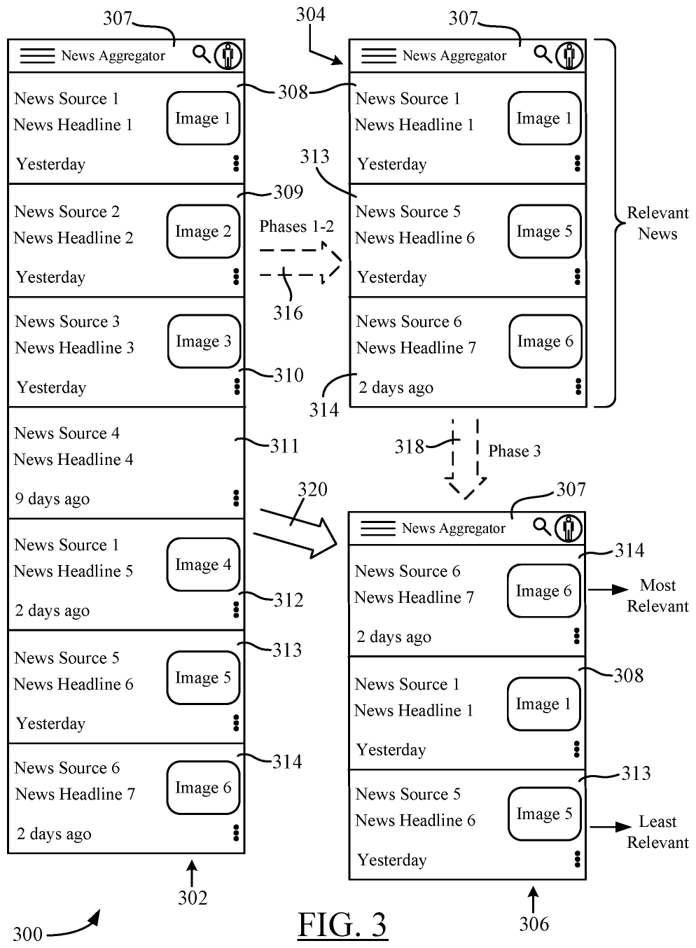

More generally, as noted at block 104 in FIG. 1, the RNS module 102 may receive a pre-sorted list of corporate client related online news articles from an online news aggregator. As mentioned before, the client may be an existing client of a company and the user (or AE) may be responsible to manage that client's account. Hence, the user may wish to periodically obtain relevant news articles mentioning or related to the client to stay on top of the latest news or market events involving the user's client. An exemplary pre-sorted list 302 is shown in FIG. 3 (which is discussed in more detail later below). Upon receiving the list at block 104, the RNS module 102 may access a database 106 (or multiple databases depending on how various types of data are stored) to retrieve the latest information related to products and/or services (if applicable) offered by the corporate entity and also the information related to the account of the client for which news articles are to be screened. The database (or multiple databases) 106 may store corporate entity-specific business data such as, for example, historical sales and marketing information (including sales calls, trips to client sites, deals made with the client, products or services sold, and the like) related to the client at issue, the current account status of the client (for example, if it is an active account, a dormant account, a delinquent account, and so on), the level of importance of the client (for example, a big volume client, a smaller client, and the like), and/or past business transactions (successful or unsuccessful) with the client (such as, for example, any quotations sent in the past, any product literature or presentation specifically designed for the client, and so on). In particular embodiments, the corporate entity-specific business data also may include an account activity scan report for the client either as part of the above-mentioned historical sales and marketing information or as a separate report. The scan report may contain information like orders placed by the client, deals offered to the client and accepted by the client, dates of recent visits to the client site, trip reports for the visits to the client site, and so on. Furthermore, in some embodiments, the corporate entity-specific business data also may include information about the status of an upcoming business meeting with a client to enable the RNS module 102 to prioritize the news related to that client (over news for other clients) if the business meeting with that client is approaching sooner. The database 106 also may store content related to the commercial capabilities of the corporate entity such as, for example, information about the latest products offered by the corporate entity, current service portfolio of the corporate entity providing details about different services offered by the company, new products to be offered by the corporate entity in the near future, and/or new services to be offered by the corporate entity in the near future. It is understood that the above examples of corporate entity-specific business data and content related to the commercial capabilities of the corporate entity are non-limiting examples. In different embodiments, additional or different types of data and content may represent such business data and/or commercial capabilities.

In particular embodiments, the RNS module 102 may use machine learning techniques to evaluate the received list of news articles (at block 104) against the above-mentioned information retrieved from the database 106 specific to the corporate entity—that is, the corporate entity-specific business data and content related to the commercial capabilities of the corporate entity. Based on the evaluation, the RNS module 102 may select only those news articles that contain news specifically relevant to the corporate client (or account) managed by the AE in the sense that the news articles may provide the requisite information to the AE that allows the AE to explore a potential business transaction with the client (as discussed in more detail with reference to FIG. 2). This news selection aspect is indicated by arrow 108 in FIG. 1.

In certain embodiments, the RNS module 102 also may receive one or more user preferences (block 110) and present the news articles at arrow 108 based on the user's preference(s). For example, the user may wish to see the links for only a pre-defined number of top-ranked articles (for example, the top three most-relevant articles). In that case, the RNS module 102 may present the results at arrow 108 starting with the most relevant article at the top and ending with the least-relevant article at the bottom. An example of such presentation is given by the subset 306 shown in FIG. 3 (discussed later). In other embodiments, a pre-defined number may be pre-programmed into the RNS module 102 as a default option. As another example, the user may prefer to review the selected articles per client based on the user's meeting schedule with the respective client in the next two weeks. In that case, the RNS module 102 may present the articles for the client having a meeting with the user nearest in time, followed by the articles for another client with whom the user is scheduled to meet thereafter, and so on. In certain embodiments, a summary version of the selected articles may be presented for relevant dates (or a few days before the scheduled appointment) on a user's electronic meeting calendar. In one embodiment, the links to the online articles selected as per user's preference may be displayed on a display screen of the user's information handling system on which the RNS module 102 is installed. In this manner, the selection of highly-relevant news articles may be automated for prompt, efficient, and fruitful review by the user.

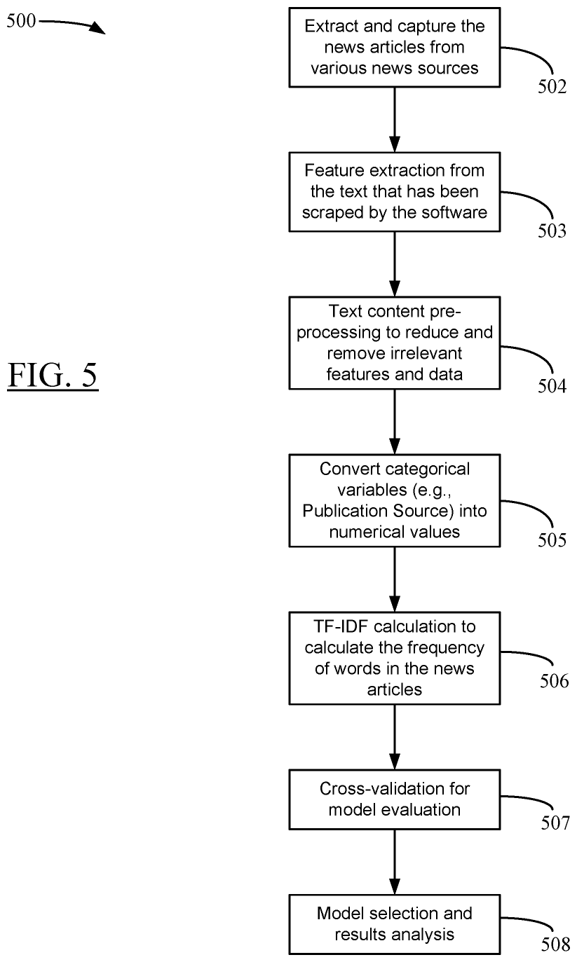

In one embodiment, the ML-based RNS module 102 may be trained using historical data including corporate entity-specific business data and information related to commercial capabilities of the corporate entity. As noted earlier, these data may have been stored in a single database such as, for example, the database 106, or in multiple databases (not shown). Some examples of these types of data are already provided before. For example, the historical data may contain information such as, for example, details of the product orders placed in the past by a specific client and profits associated with those product orders, the portfolio of clients managed by an AE, the products and/or services currently offered by the corporate entity to its enterprise customers, and the like. The training of various ML-based classifiers and analytical tools in the RNS module 102 may generate a trained version of the RNS module 102. An exemplary flowchart illustrating classifier selection as part of the training of the RNS module 102 is shown in FIG. 5, which is discussed later below. In particular embodiments, the trained version of the RNS module 102 may be deployed to receive the initial search results at block 104, obtain the corporate entity-specific relevant data from the database 106, and perform appropriate evaluation of the search results in view of the data from the database 106 to generate the selected subset of news articles (at arrow 108) as briefly discussed earlier and as also discussed in more detail later. However, for ease of discussion, the qualifier “trained” may be omitted when providing details of news selection by the RNS module 102 as per teachings of the present disclosure. In other words, the reference numeral “102” also may refer to the trained version of the RNS module as per teachings of the present disclosure, as may be evident from the context of discussion.

FIG. 2 is an exemplary flowchart 200 depicting various steps that may be performed by a computing system as per particular embodiments of the present disclosure to carry out news selection using the RNS module 102 of FIG. 1. In one embodiment, the computing system may be the system 700 shown in FIG. 7 and discussed later below. More generally, the computing system performing the steps shown in FIG. 2 may include in hardware and/or software the functionality of the RNS module 102. In one embodiment, the program code for the RNS module 102 (and other relevant program code such as the program code for an operating system managing the execution of the module 102) may be executed by a processor (such as the processor 702 in FIG. 7) in the computing system, and, upon execution of the program code, the computing system may be operative to perform the tasks illustrated in FIG. 2.

In the flowchart 200, each block represents one or more tasks that can be implemented in hardware, software, or a combination thereof. In the context of software, the blocks represent computer-executable instructions that, when executed by one or more processors, cause the processors to perform the recited tasks. Generally, computer-executable instructions include routines, programs, objects, modules, components, data structures, and the like that perform particular functions or implement particular abstract data types. The order in which the blocks are described is not intended to be construed as a limitation, and any number of the described tasks can be combined in any order and/or in parallel to implement the process shown in the flowchart 200. For discussion purpose, the process in the flowchart 200 is described with reference to FIG. 1 as discussed above and other relevant figures to be discussed later, although other models, frameworks, systems and environments may be used to implement this process.

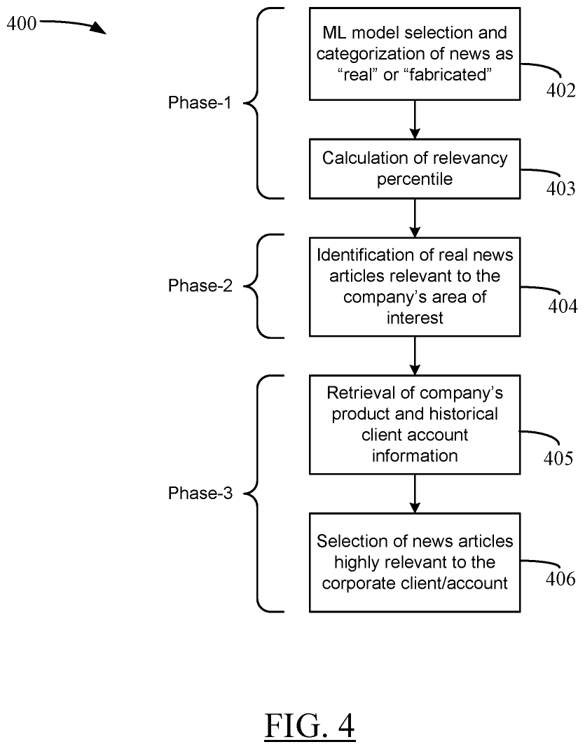

Initially, the computing system (for example, the computer system 700 in FIG. 7) may receive a list of online news articles related to a client of a corporate entity, as noted at block 202. As mentioned earlier, the list may be received from an online news aggregator and may contain news articles (or web links to the articles) generated within a pre-determined time period and pre-sorted by the online news aggregator. The pre-determined time period may be specified by a user (for example, a salesperson or an AE) associated with the corporate entity. The user may provide the pre-determined time period (for example, last 10 days, last two weeks, and the like) as part of the user-selected filter criteria input to the search engine of the news aggregator. Some news aggregators also may allow a user to specify (or select from a pre-defined list) which online news source or sources should be searched. In some embodiments, the contents of received at block 202 may be stored in a memory (such as the memory 704) of the computing system. An exemplary list of news articles is shown using the reference numeral “302” in FIG. 3 (discussed below). As noted at block 203, the computing system may identify—using an ML module such as the RNS module 102—a first subset of online news articles from the list that are relevant to a commercial area of interest specific to the corporate entity. In one embodiment, the first subset (at block 203) and the list (at block 202) may contain the same number of news articles depending on the relevance of the articles in the list. In another embodiment, the first subset may contain less news articles than the list. The tasks at block 203 may comprises the operational phases 1 and 2 of the RNS module 102 as discussed later with reference to FIG. 4. An exemplary first subset of news articles is identified using the reference numeral “304” in FIG. 3 (discussed below). Thereafter, the computing system may select—also using the ML module 102—a second subset of online news articles from within the first subset based on an analysis of corporate entity-specific business data and commercial capabilities of the corporate entity, as noted at block 204. As discussed with reference to FIG. 1, the RNS module 102 may retrieve such business data and capability content from one or more databases (such as the database 106). The second subset may contain news articles that are specifically relevant for a potential business transaction with the client. The results at arrow “108” in FIG. 1 may represent the second subset of articles presented to the user. The tasks at block 204 may comprises the operational phase 3 of the RNS module 102 as discussed later with reference to FIG. 4. An exemplary second subset of news articles is identified using the reference numeral “306” in FIG. 3 (discussed below). In one embodiment, the second subset (at block 204) and the first subset (at block 203) may contain an identical number of news articles as in case of the examples shown in FIG. 3. In another embodiment, the second subset may contain less news articles than the first subset depending on the results of the analysis performed by the RNS module 102.

In this manner, the computing system may perform an automated selection of a highly-relevant set of news articles to be presented to the user to enable the user to efficiently explore the possibility of a new business transaction with the user's client in a financially-rewarding manner, while significantly mitigating the risks associated with a manual screening/selection of such articles. The business transaction may be a simple sales call or a new sales presentation, a visit to the client's site for additional discussion, or may be a more-involved transaction such as an actual sale of a product or service. Regardless of the nature or financial worth of the transaction, it is important to point out that the additional screening afforded by the RNS module 102 not only saves countless manual hours of AEs sifting through news articles to do their jobs, but it also presents highly-relevant content to an AE so that the AE can explore new, potential business opportunities with the AE's clients. The AE may frequently miss important news in the traditional manual review of results received from a news aggregator, which can be potentially costly in the competitive marketplace. The rigorous, automated, and highly-specific screening by the RNS module 102 prevents that from happening. Furthermore, even if the news articles selected by the RNS module 102 do not contain commercially highly-beneficial information, they may provide information sufficient to prompt the AE to perform additional online searches to obtain more information about a client that can indeed result in a potential business opportunity with the client.

FIG. 3 is an exemplary illustration 300 of how search results from an online news aggregator may be screened for the most relevant news using the RNS module 102 of FIG. 1. An AE may use a web browser (not shown) on the AE's information handling system (such as the computer system 700 in FIG. 7) to access the website of a news aggregator and the enter the name of a client of the AE to search for news related to the client. An exemplary search bar on the aggregator's website is illustrated using the reference numeral “307” in FIG. 3. The search bar 307 may identify the news aggregator (by name, by trademark, or other symbol) and provide a data entry space for the AE to enter the desired search term. If the AE has subscribed to the search services of the aggregator or has logged-in to an account with the aggregator, the search bar 307 also may show the account image selected by the AE. A human inside a circle is shown as an example of such image at the right-most corner of the search bar 307 in FIG. 3. In the embodiment of FIG. 3, the AE has entered the name of AE's client in the search bar 307 and selected to search for the news articles generated within the last 10 days mentioning the AE's client. The resulting list 302 shows the news articles 308-314 received from the aggregator meeting the AE's search criteria.

Each search result 308-314 in the list 302 may identify the source of the news article and provide a link to the website of the source (such as, for example, The New York Times, CNN, Forbes, and the like), the headline of the news article in the form of a clickable link, an image (if available) associated with the news article, and the timing when the news article was generated (for example, 2 days ago, 9 days ago, and so on). In certain cases, a short summary—for example, a few sentences from the initial paragraph in the news article—also may be displayed in the search result below the news headline. It is seen from the list 302 in FIG. 3 that the search results 308 and 312 contain news articles from the same news source, but generated at different times. Furthermore, there is no image provided by the news source for the news article in the search result 311. Additionally, the search results 308-314 may be pre-sorted by the news aggregator (as noted at block 202 in FIG. 2) as per aggregator's search policy and may not be necessarily in a chronological order or even in an order from the most relevant to the least relevant. As mentioned earlier, the AE may need to review each article to find out which article or articles are specifically relevant to the AE to explore a potential business transaction with the client, which may be quite time-consuming and error-prone. The RNS module 102 removes this burden and automates the news selection process as discussed herein.

As indicated by the dotted arrow 316, in its operational phases 1 and 2 (which are discussed in more detail later with reference to FIGS. 4-6), the RNS module 102 may process the list 302 to filter all irrelevant news and select the first subset 304 containing only those news article that are relevant to a commercial area of interest specific to the corporate entity (as noted at block 203 in FIG. 2). In that regard, the RNS module 102 may access each news article in its entirety online or appropriately fetch it from the respective source for evaluation of its content. For example, if the corporate entity is a computer hardware supplier or in the business of providing Information Technology (IT) solutions, then the articles that mention the company's client acquiring a technology start-up company or considering upgrades to its computer systems may be considered relevant to the company's line of business and, hence, may be included in the first subset 304. On the other hand, articles that generally mention company's client without additional details or mention the client in the context not related to the company's line of business may be considered irrelevant and excluded from the first subset 304. In the embodiment of FIG. 3, the articles in the search results 308, 313, and 314 are considered relevant for inclusion in the first subset 304 as shown.

Thereafter, as indicated by the dotted arrow 318, in its operational phase 3 (which is discussed in more detail later with reference to FIG. 4), the RNS module 102 may further process the contents of the articles 308, 313-314 in the first subset 304 to select only those articles from the first subset 304 that are highly relevant for the AE in generating a potential, new business opportunity with the client (as noted at block 204 in FIG. 2). These articles comprise the second subset 306. As noted before, the RNS module 102 may access the database 106 to retrieve corporate product and account information to select appropriate articles for the second subset 306. As also noted before, the first subset 304 and the second subset 306 may or may not contain the same number of articles. In the context of the embodiment in FIG. 3, the first subset 304 and the second subset 306 contain the same articles, albeit in a different order. As part of its phase 3 analysis, in some embodiments, the RNS module 102 may provide an ordered presentation of the news articles in the second subset 306 starting with the most-relevant news article (here, the article 314) and ending with the least-relevant news article (here, the article 313) for the potential business transaction with the client. In other embodiments, the RNS module 102 may receive an article presentation preference from the AE (as indicated at block 110 in FIG. 1) and present the results in the second subset (like the subset 306 in FIG. 3) based on that preference.

It is noted here that the arrows 316 and 318 are shown dotted in FIG. 3 to indicate that, in certain embodiments, the execution of the tasks associated with the phases 1-3 may be transparent to the user; the user may not see the intermediate processing results (such as the news articles in the first subset 304), but may only see the final presentation of search results (such as the ordered set of articles in the second subset 306). In other words, upon receiving the input list 302, the RNS module 102 may simply present the second subset 306 to the user as indicated by the solid arrow 320. The internal processing of the RNS module 102 and generation of the first subset 304 may not be visible to the user in some embodiments.

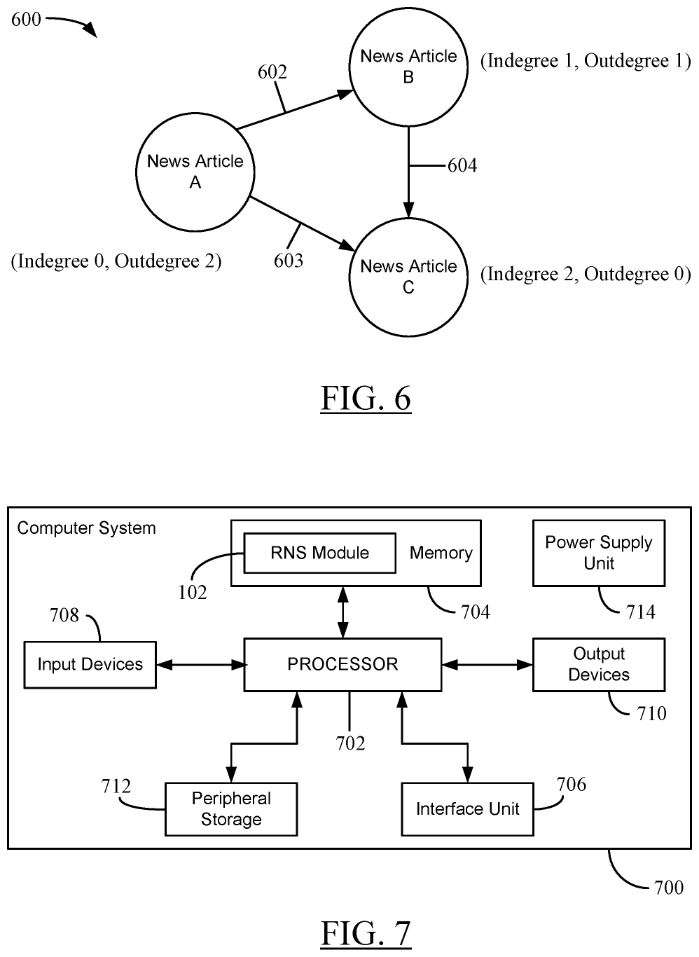

FIG. 4 is an exemplary flowchart 400 providing an overview of various operational phases of the RNS module 102 of FIG. 1 as per certain embodiments of the present disclosure. The three operational phases—phase 1, phase 2, and phase 3—mentioned earlier with reference to FIG. 3 are shown in more detail in FIG. 4. In phase 1, the RNS module 102 may perform two primary tasks: (i) selection of an ML model for classifying news articles and categorization of each news article as either “real” or “fabricated” (or suspicious), as noted at block 402 and discussed in more detail later with reference to FIG. 5; and (ii) calculation of relevancy percentile for each “real” news article, as noted at block 403 and discussed in more detail later with reference to FIG. 6. The selection of an appropriate ML classifier may be part of the training of the ML module 102, which may be initially (and, preferably, continually) trained using historical business data (such as the data and content discussed earlier with reference to database 106 in FIG. 1) and training samples of different online news articles (as discussed below with reference to FIG. 5) before being deployed to perform news selection for various users. In one embodiment, the training process may be dynamically performed in the background every time the database 106 is updated with new data pertinent to the news selection/screening aspect. Thus, in phase 1, the RNS module 102 may identify the relevance of each news generated over a certain time period and received in a list of search results from a news aggregator, and then categorize the news as either “real” news or “fabricated” news. After categorization, the RNS module 102 may remove all news articles identified as “fabricated” from subsequent analysis. In certain embodiments, the RNS module 102 also may remove the lowest-ranked “real” news based on the relevance percentile (discussed with reference to FIG. 6) of the news.

In phase 2, the RNS module 102 may determine the relevance of the news links scraped in phase 1 and identify those “real” news articles that are truly relevant to the company's area of business, as noted at block 404. In part of the news analysis in phase 2, in some embodiments, the RNS module 102 may take into account the company's current and near-future product/service portfolio offerings. After a news article is determined to be relevant to a company's line of business, the RNS module 102 may further analyze the article in phase 2 to identify business or commercial discussion specified within the article for which up-sell/cross-sell and new business opportunities may be targeted by an AE.

In phase 3, as noted at blocks 405-406, the RNS module 102 may retrieve company's product offering (and/or service offering) and historical client account information from one or more databases (as represented, for example, by the database 106 in FIG. 1) to determine which news articles hold the most business potential for an AE and are aligned with the AE's visit schedule (if any) as well. At the conclusion of phase 3, the RNS module 102 may select only those news articles (from the original list received from the news aggregator) that are highly relevant to the corporate client or account (block 406) to help improve an AE's productivity by curating and presenting the most relevant news that will not only be related to an AE's assigned account(s)/customer(s), but will also be based on the corporate entity's product/service offerings and historical context of orders, deals, AE's trip reports to client sites, and the like.

FIG. 5 shows an exemplary flowchart 500 of how an ML classifier may be selected as part of generating a trained version of the RNS module 102 of FIG. 1 as per particular embodiments of the present disclosure. In some embodiments, a computing system (such as the computing system 700 in FIG. 7) may perform the tasks shown in FIG. 5 to carry out the training of the RNS module 102. A software (for example, a data mining software) that also contains the RNS module 102 may be executed by the computing system to perform the tasks shown in FIG. 5. Initially, as noted at block 502, training samples of online news articles may be extracted and captured from various news sources using, for example, the software that also contains the RNS module 102. In certain embodiments, the training samples may include many different types of news articles related to the clients of the corporate entity. In other embodiments, the training set of articles may be related to the corporate entity's line of business. At block 503, relevant features (for example, the subjective information contained in an article, the focus of the author or contributors of the article, sales figures mentioned in the article, and so on) and data may be extracted by the software from the text that has been scraped by the software at block 502. Routine pre-processing of the extracted text content may be performed at block 504 to reduce and remove irrelevant features and data (such as, for example, quotation marks, non-text data, and the like). At block 505, different categorical variables (for example, name of the publication, online source of the article, type of the article (for example, related to finance, IT, food sector, and so on), and the like) associated with each sample article may be converted into corresponding numerical values for subsequent analysis. At block 506, Term Frequency-Inverse Document Frequency (TF-IDF) calculations may be performed for each sample news article to calculate the frequency of various words in the news article. A TF-IDF calculation may reflect how important a word is to a document. The TF-IDF value may increase proportionally to the number of times a word appears in a news article, and may be offset by the number of articles in the training samples of articles that contain the same word.

Thereafter, different ML techniques/models may be used as classifiers to classify each sample article as containing “real” or “fabricated” (or suspicious) news to establish authenticity of the news article. Some exemplary ML classifiers include a neural-network based Support Vector Machine (SVM) classifier (linear), a Random Forest classifier, a Logistic Regression model, and a Multinomial Naive Bayes model. These classifiers may use deep learning based Natural Language Processing (NLP) techniques along with Sentiment Analysis models to classify the news content in a training sample as “real” or “fabricated”. Sentiment Analysis models may use data mining processes, text analysis, and other language-processing techniques to identify, extract, and capture data for analysis to discern subjective opinion of a document or collection of documents like blog posts, news articles, social media feeds, and so on. An ML classifier may filter out or remove the news articles that are identified as “fabricated” and keep only the “real” news articles for further classification. The performance of each ML classifier/model—as observed in terms of its classification of a sample as “real” or “fabricated”—may be evaluated through cross-validation, as noted at block 507. As part of cross-validation, the performance of each ML classifier may be evaluated on a set of test samples of news articles. The test samples may be complementary to the training samples. For example, in a k-fold cross-validation method, the input data may be split into “k” subsets of data. An ML model may be trained on “k-1” subsets (all but one subset), and then evaluated on the subset that was not used for training. This process may be repeated “k” times, with a different subset reserved for evaluation (and excluded from training) each time. In the embodiment of FIG. 5, the cross-validation may result in the selection of the Logistic Regression model as the classifier to be included in the trained version of the ML module 102. In certain embodiments, the Logistic Regression model may provide the best accuracy of classification among all models.

At block 508 in FIG. 5, the final classifier model (here, the Logistic Regression model) may be selected for inclusion in the trained version of the ML module 102 and subsequently used to analyze the search results (such as, for example, the list 302 shown in FIG. 3) received from a news aggregator when the ML module 102 is deployed to receive the list 302 and perform the news selection as per teachings of the present disclosure. As noted before, the ML module 102 may be additionally (and, preferably, continually) trained using historical, corporate entity-specific data before it is deployed to perform the news selection as per teachings of the present disclosure. In one embodiment, the training process may be dynamically performed in the background every time the historical data is updated with new data as new product orders are placed, new sales calls are made (for example, based on the earlier selection of the news articles by the RNS module 102), new profit information becomes available, and so on. The training of the ML module 102, in turn, may be similarly updated to provide a robustly-trained RNS module 102. As noted before, such historical data may have been stored in a database such as, for example, the corporate product and account database 106 in FIG. 1. In other embodiments, additional or different information also may be stored as part of the historical data.

As noted with reference to FIG. 4, the tasks discussed with reference to FIGS. 5 and 6 comprise the operational phase-1 of the RNS module 102. Therefore, once the appropriate classifier model is selected at block 508 in FIG. 5 and a trained version of the RNS module 102 is generated, the trained RNS module 102 may be applied to the news links received in the list 302 of initial search results from a news aggregator. As mentioned earlier, the news aggregator may allow a user to select one or more sources from which news may be collected as well as the recency of the news (for example, the news generated within the last week, or the news generated in the last 24 hours, and the like). The search results in the list 302 may be then analyzed by the RNS module 102 to classify each news article as “real” or “fabricated.” In particular embodiments, news classified as “fabricated” may be filtered out and removed before the relevance percentiles are calculated as per the embodiment in FIG. 6.

FIG. 6 is an exemplary block diagram 600 illustrating the determination of relevance percentile by the RNS module 102 of FIG. 1 as per some embodiments of the present disclosure. As noted above, the initial list 302 (FIG. 3) may be filtered to remove “fabricated” news therefrom. The relevancy of the remaining group of “real” news articles may be calculated thereafter by assigning a corresponding relevance percentile to each such article. In that regard, a corresponding indegree score and a corresponding outdegree score for each such “real” article may be determined as illustrated in FIG. 6. An indegree score of an article reflects the number of times a news article is being cited by other articles in the group. On the other hand, an outdegree score of an article reflects the number of articles being cited by the article under consideration. In certain embodiments, indegrees increase the relevancy score of an article, whereas outdegrees above a certain threshold (which may be pre-set by a user) may lessen the relevancy score of the article. In the illustration in FIG. 6, the inter-relationship among three exemplary news articles A, B, and C is shown by uni-directional arrows. For example, an outgoing arrow 602 from the article A to the article B indicates that the article A cites the article B, but not vice versa. Similarly, another outgoing arrow 603 from the article A to the article C also indicates that the article A cites the article C, but not vice versa. As a result, in the given set of three news articles (A, B, and C), the indegree score of article A is zero, whereas the outdegree score of article A is 2. Similar indegree and outdegree scores for the articles B and C are also noted in FIG. 6. For example, the article B has been cited by the article A (as indicated by the incoming arrow 602 for article B), giving rise to the indegree score of 1 for the article B. On the other hand, the article C has been cited by both the articles A and B (as indicated by incoming arrows 603, 604 for article C), resulting in the indegree score of 2 for the article C. The outdegree scores of the articles B and C are similarly calculated.

In particular embodiments, the relevance percentile of a news article may be calculated as a difference between the corresponding indegree score and the corresponding outdegree score of the article. Thus, in the context of FIG. 6, the article C may be assigned the highest relevance percentile of 2 because it has the highest indegree score (=2) and the lowest outdegree score (=0). On the other hand, the article B may have the relevance percentile of zero, whereas the article A may have negative relevance percentile. In some embodiments, only those articles having their outdegree score below a pre-defined threshold (such as, for example, less than or equal to 2) may be assigned a relevance percentile and considered for further evaluation in phases 2 and 3 of the RNS module 102. In other words, an article may be considered for further evaluation if its relevance percentile is at or above a pre-defined threshold (such as, for example, greater than or equal to zero).

As noted at block 404 in FIG. 4, in its operational phase 2, the RNS module 102 may further evaluate the news articles scraped in phase 1 (and given respective relevance percentile) to determine how relevant those articles are to the company's commercial area of interest. The news articles curated at the end of phase 1 may be analyzed on the basis of their tags and content to determine the category to which the news article belongs such as, for example, finance, Information Technology (IT), food service, and so on. The content of the articles also may be analyzed using NLP techniques (such as, for example, the “bag of words” method) and the frequency count of the words in an article may be used to categorize the corporate area of interest to which the news belongs. Once the area(s) to which the news belongs are classifier, the articles may be filtered out based on the area of interest the user/AE wishes to inquire about (here, the commercial area of interest of the corporate employer of the AE). For example, as mentioned earlier, if an AE is working for a corporate entity that provides technological products and/or services and if the AE manages the account of a national burger chain, then a news article discussing introduction of a new burger or a new burger sauce by the AE's client may be irrelevant to the AE's line of work. On the other hand, news about AE's client acquiring a new technology start-up may be highly relevant because the client may choose to invest heavily in Information Technology (IT) infrastructure/hardware as a result of the acquisition. In this example, news tagged against IT (the area of interest for AE's company) may be retained and other news may be filtered out and removed (such as the news about launch of a new burger).

In certain embodiments, once the news articles relating to the corporate entity's area of interest are identified, the RNS module 102 may again parse those articles (as part of its processing under phase 2) using NLP techniques (such as the earlier-mentioned “bag of words” method) to determine the count for the business (or corporate area of interest) mentioned in each article. In particular embodiments, once the count for the business mentioned crosses a user-defined threshold frequency (or a default threshold), the news article may be classified as relevant to the corporate entity's commercial area of interest (that is, the news that has the potential to impact the company's business/revenue).

In this manner, at the conclusion of its operational phases 1 and 2 (identified by exemplary blocks 402-404 in FIG. 4), the RNS module 102 may select a specific set of news articles in which each news article is relevant to the commercial area of interest of the corporate entity and has the corresponding relevance percentile above a pre-defined threshold. In the context of the exemplary list 302 in FIG. 2, this set of news articles is given by the first subset 304 containing articles 308, 313, and 314.

After the conclusion of phases 1 and 2, the RNS module 102 may execute its operational phase 3 (an example of which is given at blocks 405-406 in FIG. 4) to further screen the articles short-listed in the first subset (such as the subset 304 in FIG. 3) resulting from phases 1 and 2. In phase 3, the RNS module 102 may access one or more databases (such as the database 106 in FIG. 1) to gather customer account information (such as the current status of the account), corporate entity-specific business data, and information about commercial capabilities of the corporate entity to determine if the news screened in phases 1 and 2 are indeed relevant to the client/account or not. Some examples of data retrieved from the database 106 as part of analysis in phase 3 are already provided before and, hence, are not repeated here for the sake of brevity. Based on the relevancy of the news generated at the end of phase 2 and the information retrieved from the database 106, the RNS module 102 may determine whether there is a match between the generated news and an active client account. In one embodiment, this can be achieved with the help of a correlation matrix matching the names of active client accounts of the corporate entity with the business names mentioned with highest frequency in the articles under review. Based on the matches, in one embodiment, the articles may be presented to the user/AE in a second subset (such as the subset 306 in FIG. 3) starting with the most-relevant news article and ending with the least-relevant news article in terms of the usefulness of the article for providing information to the AE for a potential business transaction with the client. In another embodiment, as mentioned earlier, the articles in the second subset may be presented to the user based on an article presentation preference received from the user. Thus, at the conclusion of phase 3, the RNS module 102 may provide an automatic recommendation of a set of news articles (such as those presented in the second subset 306) intelligently selected based on an analysis of corporate entity-specific business data and commercial capabilities of the corporate entity (as noted at block 204 in FIG. 2). This helps the AE in seizing a potential business opportunity with the client, which the AE may have missed under the current system of manual review of initial search results (such as those shown in the list 302 in FIG. 3).

FIG. 7 illustrates an example configuration of a computer system 700 that can be used to implement the news selection methodology described herein. In particular embodiments, the RNS module 102 of FIG. 1 may be used to implement the news selection methodology as per teachings of the present disclosure. The computer system (or computing device) 700 may be suitably configured to implement the functionality of the RNS module 102. The computer system 700 may include one or more processors 702, a memory unit 704, an interface unit 706 providing communication interfaces, one or more input devices 708, one or more output devices 710, and a peripheral storage unit 712, connected to the processor 702 as shown and configured to communicate with each other, such as via one or more system buses (not shown) or other suitable connection. In some embodiments, the computer system 700 may be an information-handling system mentioned before.

In one embodiment, the input devices 708 may provide user inputs—such as user inputs received at block 110 in FIG. 1—to the processor 702 and the RNS module 102 for further processing as per teachings of the present disclosure. The input devices 708 may include, for example, a touchpad, a camera, a computer keyboard, a touch-screen, a joystick, a physical or virtual “clickable button,” a computer mouse/pointing device, and the like. A display screen is an example of the output device 710. Other examples of an output device include a graphics/display device, a computer screen or monitor, an alarm system, or any other type of data output device. In some embodiments, the input device(s) 708 and the output device(s) 710 may be coupled to the processor 702 via an I/O or peripheral interface(s). In some embodiments, the computer system 700 may include more than one instance of the devices shown. In various embodiments, all of the components shown in FIG. 7 may be housed within a single housing. In other embodiments, the computer system 700 may not include all of the components shown in FIG. 7. Furthermore, the computing device 700 may be configured as a standalone system, as a server system, as a client system, or in any other suitable form factor.

The processor 702 is a hardware device that may include a single processing unit or a number of processing units, all of which may include single or multiple computing units or multiple cores. When the computing device 700 is a multiprocessor system, there may be more than one instance of the processor 702 or there may be multiple processors coupled to the processor 702 via their respective interfaces (not shown). The processor 702 may include an integrated Graphics Processing Unit (GPU) or the GPU may be a separate processor device in the system 700. The processor 702 may be implemented as one or more microprocessors, microcomputers, microcontrollers, Digital Signal Processors (DSPs), Central Processing Units (CPUs), Graphics Processing Units (GPUs), state machines, logic circuitries, and/or any devices that manipulate signals based on operational instructions. Among other capabilities, the processor 702 may be configured to fetch and execute computer-readable instructions stored in the memory 704, the peripheral storage 712, or other computer-readable media. In some embodiments, the processor 702 may be a System on Chip (SoC).

The memory 704 and the peripheral storage unit 712 are examples of non-transitory computer media (e.g., memory storage devices) for storing instructions that can be executed by the processor 702 to perform the various functions described herein. For example, the memory unit 704 may include both volatile memory and non-volatile memory (e.g., RAM, ROM, or the like) devices. Further, in particular embodiments, the peripheral storage unit 712 may include one or more mass storage devices such as, for example, hard disk drives, solid-state drives, removable media, including external and removable drives, memory cards, flash memory, floppy disks, optical disks (e.g., CD, DVD), a storage array, a network attached storage, a storage area network, or the like. Both memory 704 and mass storage devices constituting the peripheral storage 712 may be collectively referred to as memory or computer storage media herein, and may be a media capable of storing computer-readable, processor-executable program instructions as computer program code that can be executed by the processor 702 as a particular machine configured for carrying out the operations and functions described in the implementations herein.

The computing device 700 may also include one or more communication interfaces as part of its interface unit 706 for exchanging data via a network. The communication interfaces can facilitate communications within a wide variety of networks and protocol types, including wired networks (e.g., Ethernet, Digital Subscriber Loop (DSL), Data Over Cable Service Interface Specification (DOCSIS), Fiber Optics network, Universal Serial Bus (USB), etc.) and wireless networks (e.g., Wireless Local Area Network (WLAN), Global System for Mobile Communications (GSM), Code Division Multiple Access (CDMA), Institute of Electrical and Electronics Engineers (IEEE) standard 802.11, Bluetooth®, Wireless USB, cellular, satellite, etc.), the Internet, and the like. Communication interfaces in the interface unit 706 can also provide communication with external storage (not shown), such as in a storage array, network attached storage, storage area network, one or more databases (such as the corporate database 106 in FIG. 1 when implemented as an external storage), or the like.

The computer storage media, such as the memory 704 and the mass storage devices in the peripheral storage 712, may be used to store software and data. For example, the computer storage media may be used to store the operating system (OS) for the computing device 700, various device drivers for the device 700, various inputs provided by the user during the implementation and operation of the RNS module 102, and the data such as audio content, video content, text data, streaming content, data retrieved from the database 106 shown in FIG. 1, search results received from a news aggregator and content of related articles from various online sources discussed with reference to FIGS. 1-6, or any other type of content. In some embodiments, the database 106 (FIG. 1) may be a part of the peripheral storage 712. In other embodiments, the database 106 may be included as part of the system memory 704. The computer storage media also may store software applications such as a word processing application, a spreadsheet application, a web browser, the RNS module 102, and the like. The program code for the software applications and the OS may be executed by the processor 702.

In one embodiment, a non-transitory, computer-readable data storage medium, such as, for example, the system memory 704 or the peripheral data storage unit 712 may store program code or software for the RNS module 102 as per particular embodiments of the present disclosure. In the embodiment of FIG. 7, the system memory 704 is shown to include such program code. In the embodiment of FIG. 7, the RNS module 102 may operate in conjunction with the host OS (not shown) of the computing device 700 and a web browser (not shown). The processor 702 may be configured to execute the program code for the RNS module 102, whereby the computer system 700 may be operative to perform various tasks associated with the RNS module 102 as per the teachings of the present disclosure. In one embodiment, such tasks may include, for example, the process steps illustrated in FIGS. 2 and 4-5 as well as other tasks discussed with reference to FIGS. 1, 3, and 6 such as, for example, training of the RNS module 102, reception of the list of search results from an online news aggregator, retrieval of historical corporate data and other relevant commercial content from the database 106, evaluation of the news articles against the corporate data and commercial content, selection of news articles highly relevant to a client account, and so on. The program code or software for the RNS module 102 may be proprietary software or open source software which, upon execution by the processor 702, may enable the computer system 700 to perform operations related to news selection as per teachings of the present disclosure.

In particular embodiments, the computing device 700 may include an on-board power supply unit 714 to provide electrical power to various system components illustrated in FIG. 7. The power supply unit 714 may receive batteries or may be connectable to an AC electrical power outlet. In one embodiment, the power supply unit 714 may convert solar energy or other renewable energy into electrical power.

The example systems and devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability, and, hence, are considered machine-implemented. Generally, any of the functions described with reference to the figures can be implemented using software, hardware (e.g., fixed logic circuitry) or a combination of these implementations. The terms “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions), such as the program code for the RNS module 102, that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations or embodiments, as described and as illustrated in the drawings. However, this disclosure is not limited to the implementations described and illustrated herein, but can extend to other implementations, as would be known or as would become known to those skilled in the art. Reference in the specification to “one embodiment,” “particular embodiments,” “this implementation,” “some embodiments”, or other terms of similar import, means that a particular feature, structure, or characteristic described is included in at least one implementation or embodiment, and the appearances of these phrases in various places in the specification are not necessarily all referring to the same implementation/embodiment.

Although the present disclosure has been described in connection with several embodiments, the disclosure is not intended to be limited to the specific forms set forth herein. On the contrary, it is intended to cover such alternatives, modifications, and equivalents as can be reasonably included within the scope of the disclosure as defined by the appended claims.

What is claimed is:

1. A method comprising:
receiving, by a computing system, a list of online news articles related to a client of a corporate entity, wherein the list contains news articles generated within a pre-determined time period and pre-sorted by an online news aggregator;
identifying, by the computing system using a machine learning (ML) module, a first subset of online news articles from the list that are relevant to a commercial area of interest specific to the corporate entity; and
selecting, by the computing system using the ML module, a second subset of online news articles from within the first subset based on an analysis of corporate entity-specific business data and commercial capabilities of the corporate entity, wherein the second subset contains news articles that are specifically relevant for a potential business transaction with the client.

2. The method of claim 1, wherein the pre-determined time period is specified by a user associated with the corporate entity.

3. The method of claim 1, wherein one of the following applies:
the first subset and the list contain an identical number of news articles; and
the first subset contains less news articles than the list.

4. The method of claim 1, wherein one of the following applies:
the second subset and the first subset contain an identical number of news articles; and
the second subset contains less news articles than the first subset.

5. The method of claim 1, wherein identifying the first subset comprises:
classifying, by the computing system using the ML module, each news article in the list as one of the following:
a real news article, and
a fabricated news article;
assigning, by the computing system using the ML module, a corresponding relevance percentile to each news article in the list that is classified as the real news article; and
selecting, by the computing system using the ML module, each news article that is relevant to the commercial area of interest and that has the corresponding relevance percentile above a pre-defined threshold as comprising the first subset.

6. The method of claim 5, wherein assigning the corresponding relevance percentile comprises:
determining, by the computing system using the ML module, a corresponding indegree score and a corresponding outdegree score of each news article in the list that is classified as the real news article; and
calculating, by the computing system using the ML module, the corresponding relevance percentile based on a difference between the corresponding indegree score and the corresponding outdegree score of each news article that is classified as the real news article.

7. The method of claim 1, further comprising:
providing, by the computing system using the ML module, an ordered presentation of the online news articles in the second subset starting with a most-relevant news article and ending with a least-relevant news article for the potential business transaction with the client.

8. The method of claim 1, wherein selecting the second subset comprises:
receiving, by the computing system using the ML module, an article presentation preference from a user associated with the corporate entity; and
presenting, by the computing system using the ML module, the online news articles in the second subset to the user based on the article presentation preference.

9. The method of claim 1, wherein selecting the second subset comprises:
accessing, by the computing system using the ML module, at least one database to retrieve the corporate entity-specific business data and content related to the commercial capabilities of the corporate entity.

10. The method of claim 9, wherein the corporate entity-specific business data comprise at least one of the following:
historical sales and marketing information related to the client;
an account activity scan report for the client;
status of an upcoming business meeting with the client;
current account status of the client; and
past business transactions with the client; and
wherein the content related to the commercial capabilities of the corporate entity comprises at least one of the following:
latest products offered by the corporate entity;
new products to be offered by the corporate entity in a near future;
current service portfolio of the corporate entity; and
new services to be offered by the corporate entity in the near future.

11. The method of claim 1, further comprising:
training, by the computing system, the ML module using online news articles from a plurality of news sources to generate a trained version of the ML module;
wherein identifying the first subset comprises:
identifying the first subset using the trained version of the ML module; and
wherein selecting the second subset comprises:
selecting the second subset using the trained version of the ML module.

12. The method of claim 11, wherein the trained version of the ML module comprises a Logistic Regression based classifier.

13. A computing system comprising:
a memory storing program instructions; and
a processing unit coupled to the memory and operable to execute the program instructions, which, when executed by the processing unit, cause the computing system to:
receive a list of online news articles related to a client of a corporate entity, wherein the list contains news articles generated within a pre-determined time period and pre-sorted by an online news aggregator;
identify, using a machine learning (ML) module, a first subset of online news articles from the list that are relevant to a commercial area of interest specific to the corporate entity; and
select, using the ML module, a second subset of online news articles from within the first subset based on an analysis of corporate entity-specific business data and commercial capabilities of the corporate entity, wherein the second subset contains news articles that are specifically relevant for a potential business transaction with the client.

14. The computing system of claim 13, wherein the program instructions, upon execution by the processing unit, cause the computing system to:
classify each news article in the list as one of the following:
a real news article, and
a fabricated news article;
assign a corresponding relevance percentile to each news article in the list that is classified as the real news article; and
select each news article that is relevant to the commercial area of interest and that has the corresponding relevance percentile above a pre-defined threshold as comprising the first subset.

15. The computing system of claim 13, wherein the program instructions, upon execution by the processing unit, cause the computing system to perform one of the following:
provide an ordered presentation of the online news articles in the second subset starting with a most-relevant news article and ending with a least-relevant news article for the potential business transaction with the client; and
present the online news articles in the second subset to a user associated with the corporate entity based on an article presentation preference received from the user.

16. The computing system of claim 13, wherein the corporate entity-specific business data comprise at least one of the following:
historical sales and marketing information related to the client;
an account activity scan report for the client;
status of an upcoming business meeting with the client;
current account status of the client; and
past business transactions with the client; and
wherein the commercial capabilities of the corporate entity comprise at least one of the following:
latest products offered by the corporate entity;
new products to be offered by the corporate entity in a near future;
current service portfolio of the corporate entity; and
new services to be offered by the corporate entity in the near future.

17. A computer program product comprising a non-transitory computer-usable medium having computer-readable program code embodied therein, the computer-readable program code adapted to be executed by a computing system to implement a method comprising:
receiving a list of online news articles related to a client of a corporate entity, wherein the list contains news articles generated within a pre-determined time period and pre-sorted by an online news aggregator;
identifying, using a machine learning (ML) module, a first subset of online news articles from the list that are relevant to a commercial area of interest specific to the corporate entity; and
selecting, using the ML module, a second subset of online news articles from within the first subset based on an analysis of corporate entity-specific business data and commercial capabilities of the corporate entity, wherein the second subset contains news articles that are specifically relevant for a potential business transaction with the client.

18. The computer program product of claim 17, wherein the method further comprises:
classifying each news article in the list as one of the following:
a real news article, and
a fabricated news article;
assigning a corresponding relevance percentile to each news article in the list that is classified as the real news article; and
selecting each news article that is relevant to the commercial area of interest and that has the corresponding relevance percentile above a pre-defined threshold as comprising the first subset.

19. The computer program product of claim 17, wherein the method further comprises one of the following:
providing an ordered presentation of the online news articles in the second subset starting with a most-relevant news article and ending with a least-relevant news article for the potential business transaction with the client; and
presenting the online news articles in the second subset to a user associated with the corporate entity based on an article presentation preference received from the user.

20. The computer program product of claim 17, wherein the corporate entity-specific business data comprise at least one of the following:
historical sales and marketing information related to the client;
an account activity scan report for the client;
status of an upcoming business meeting with the client;
current account status of the client; and
past business transactions with the client; and
wherein the commercial capabilities of the corporate entity comprise at least one of the following:
latest products offered by the corporate entity;
new products to be offered by the corporate entity in a near future;
current service portfolio of the corporate entity; and
new services to be offered by the corporate entity in the near future.
